(19) United States
(12) Patent Application Publication
(10) Pub. No.: US 2026/0060305 A1
(43) Pub. Date: Mar. 5, 2026

(54) HEATING STRUCTURE AND AEROSOL GENERATING DEVICE

(71) Applicant: SMOORE INTERNATIONAL HOLDINGS LIMITED, George Town (KY)

(72) Inventors: Hong LI, Shenzhen (CN); Lei MA, Shenzhen (CN); Fang XIE, Shenzhen (CN); Guo ZHANG, Shenzhen (CN); Pengchong ZHANG, Shenzhen (CN); Hongming ZHOU, Shenzhen (CN); Rihong LI, Shenzhen (CN); Xingfu ZHANG, Shenzhen (CN)

(21) Appl. No.: 19/383,483

(22) Filed: Nov. 7, 2025

Related U.S. Application Data
(63) Continuation of application No. PCT/CN2024/091484, filed on May 7, 2024.

(30) Foreign Application Priority Data
May 9, 2023 (CN) 202310519854.X

(51) Int. Cl. A24F 40/46; A24F 40/20; A24F 40/51

(52) U.S. Cl. CPC A24F 40/46; A24F 40/51; A24F 40/20

(57) ABSTRACT

A heating structure includes: a heating element for generating infrared light in a power-on state; a tube body that allows the infrared light to penetrate through; and a thermal resistance temperature measuring element. The heating element is at least partially accommodated in the tube body. The thermal resistance temperature measuring element comprises a first temperature measuring segment and a second temperature measuring segment that are provided on a peripheral surface of the tube body, the first temperature measuring segment and the second temperature measuring segment being connected so as to form a temperature measuring loop. The peripheral surface of the tube body includes a plurality of temperature zones along an axial direction of the tube body. A resistance of the first temperature measuring segment is greater than a resistance of the second temperature measuring segment. The first temperature measuring segment is provided corresponding to one temperature zone.

### CROSS-REFERENCE TO PRIOR APPLICATION

This application is a continuation of International Patent Application No. PCT/CN2024/091484, filed on May 7, 2024, which claims priority to Chinese Patent Application No. 202310519854.X, filed on May 9, 2023. The entire disclosure of both applications is hereby incorporated by reference herein.

### FIELD

The present application relates to the technical field of heat-not-burning (HNB) atomization, in particular to a heating structure and an aerosol generating device.

### BACKGROUND

In the technical field of heat-not-burning (HNB) atomization, heating methods such as heating by a central heating element or by a peripheral heating element are employed generally. The common practice is that the heating element generates heat, and the heat is then directly transferred to an aerosol generating substrate through heat conduction. The substrate will generally be atomized within a temperature range of 350° C. or less. This heating method has a disadvantage in that the heating element directly or indirectly conducts the heat to the aerosol generating substrate through a solid material. This requires that the operating temperature of the heating element not be too high; otherwise, it will cause the substrate to overheat, thereby affecting the vaping experience. Therefore, temperature measuring and control become very important. In the related art, the temperature of the heating element is not uniformly distributed, and temperature gradients and differences exist in different parts of the heating element. Thus, how to detect and more accurately reflect the temperature of the heating element is one of key issues studied by a person skilled in the art.

### SUMMARY

In an embodiment, the present invention provides a heating structure, comprising: a heating element configured to generate infrared light in a power-on state; a tube body configured to allow the infrared light to penetrate through; and a thermal resistance temperature measuring element, wherein the heating element is at least partially accommodated in the tube body, wherein the thermal resistance temperature measuring element comprises a first temperature measuring segment and a second temperature measuring segment that are provided on a peripheral surface of the tube body, the first temperature measuring segment and the second temperature measuring segment being connected so as to form a temperature measuring loop, wherein the peripheral surface of the tube body comprises a plurality of temperature zones along an axial direction of the tube body, wherein a resistance of the first temperature measuring segment is greater than a resistance of the second temperature measuring segment, and wherein the first temperature measuring segment is provided corresponding to one temperature zone of the plurality of temperature zones on the peripheral surface of the tube body.

### BRIEF DESCRIPTION OF THE DRAWINGS

Subject matter of the present application will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic perspective view of a heating structure in a first embodiment of the present application from one perspective;

FIG. 2 is a schematic diagram of an overall structure of a heating structure in a first embodiment of the present application from one perspective;

FIG. 3 is a schematic cross-sectional view along A-A of FIG. 2;

FIG. 4 is a schematic structural diagram of a thermal resistance temperature measuring element of a heating structure in a first embodiment of the present application;

FIG. 5 is a schematic structural diagram of a heating structure in a first embodiment of the present application after being inserted into an aerosol generating substrate;

FIG. 6 is a schematic structural diagram of a heating structure in a first embodiment of the present application after being inserted into an aerosol generating substrate;

FIG. 7 is a schematic structural diagram of a heating structure in a first embodiment of the present application after being inserted into an aerosol generating substrate;

FIG. 8 is a schematic structural diagram of a heating structure in a first embodiment of the present application after being inserted into an aerosol generating substrate;

FIG. 9 is a schematic diagram of an overall structure of a heating structure in a second embodiment of the present application;

FIG. 10 is a schematic structural diagram of a thermal resistance temperature measuring element of a heating structure in a second embodiment of the present application;

FIG. 11 is a schematic structural diagram of a thermal resistance temperature measuring element of a heating structure in a third embodiment of the present application;

FIG. 12 is a schematic structural diagram of a thermal resistance temperature measuring element of a heating structure in a fourth embodiment of the present application;

FIG. 13 is a schematic structural diagram of an aerosol generating device in an embodiment of the present application; and

FIG. 14 is a schematic transverse cross-sectional view of a heating portion of a heating element of a heating structure in a first embodiment of the present application.

### DETAILED DESCRIPTION

In an embodiment, the present invention provides a heating structure and an aerosol generating device.

In an embodiment, the present invention provides a heating structure. The heating structure includes a heating element that generates infrared light in a power-on state, a tube body that allows the infrared light to penetrate through, and a thermal resistance temperature measuring element;
the heating element is at least partially accommodated in the tube body;
the thermal resistance temperature measuring element includes a first temperature measuring segment and a second temperature measuring segment that are provided on the peripheral surface of the tube body; the first temperature measuring segment and the second temperature measuring segment are connected to form a temperature measuring loop; and
the peripheral surface of the tube body includes a plurality of temperature zones along the axial direction of the tube body,
where the resistance of the first temperature measuring segment is greater than the resistance of the second temperature measuring segment, and the first temperature measuring segment is provided corresponding to one of the temperature zones on the peripheral surface of the tube body.

A heating structure is constructed. The heating structure includes a heating element that generates infrared light in a power-on state, a tube body that allows the infrared light to penetrate through, and a thermal resistance temperature measuring element;
the heating element is at least partially accommodated in the tube body;
the thermal resistance temperature measuring element includes a first temperature measuring segment and a second temperature measuring segment that are provided on the peripheral surface of the tube body; the first temperature measuring segment and the second temperature measuring segment are connected to form a temperature measuring loop;
the peripheral surface of the tube body includes a plurality of temperature zones along the axial direction of the tube body; and
the thermal resistance temperature measuring element includes at least the first temperature measuring segment and the second temperature measuring segment,
where the width of the first temperature measuring segment is less than the width of the second temperature measuring segment, and the first temperature measuring segment is provided corresponding to one of the temperature zones on the peripheral surface of the tube body; and/or
the thickness of the first temperature measuring segment is less than the thickness of the second temperature measuring segment, and the first temperature measuring segment is provided corresponding to one of the temperature zones on the peripheral surface of the tube body.

Preferably, a ratio of a resistance value of the first temperature measuring segment to a resistance value of the second temperature measuring segment is greater than or equal to 2.

Preferably, the first temperature measuring segment extends along the peripheral direction of the tube body; the second temperature measuring segment extends along the axial direction of the tube body; and one end of the second temperature measuring segment is connected to the first temperature measuring segment, and the other end of the second temperature measuring segment is connected to a power supply.

Preferably, the second temperature measuring segment includes a first part and a second part that extend along the axial direction of the tube body;
the first temperature measuring segment is connected between one end of the first part of the second temperature measuring segment and one end of the second part of the second temperature measuring segment; and
the other end of the first part of the second temperature measuring segment and the other end of the second part of the second temperature measuring segment are connected to the power supply.

Preferably, the peripheral surface of the tube body includes two symmetrical semi-circular arc surface regions, and the first part and the second part of the second temperature measuring segment are entirely located on one of the semi-circular arc surface regions.

Preferably, the second temperature measuring segment includes a plurality of regions having different widths, and the width of a region close to the first temperature measuring segment is less than the width of a region away from the first temperature measuring segment.

Preferably, the width of the second temperature measuring segment gradually decreases in the direction towards the first temperature measuring segment.

Preferably, the second temperature measuring segment includes an electrode, and the electrode is connected between the power supply and the first temperature measuring segment.

Preferably, a material of the electrode includes one or more of gold, silver, platinum, and copper.

Preferably, a material of the part of the second temperature measuring segment except the electrode includes one or more of platinum, gold, silver, chromium, and nickel.

Preferably, the first temperature measuring segment extends along the peripheral direction of the tube body for one circle to form an annulus.

Preferably, the length of the first temperature measuring segment extending along the peripheral direction of the tube body is less than the circumference of the tube body.

Preferably, a material of the first temperature measuring segment includes one or more of platinum, gold, silver, chromium, and nickel.

Preferably, the heating structure further includes a glaze layer provided on the surface of the first temperature measuring segment and/or the second temperature measuring segment.

Preferably, a material of the glaze layer includes SiO₂.

Preferably, the weight percentage of SiO₂ is greater than or equal to 95%.

Preferably, temperature coefficients of resistance (TCRs) of the first temperature measuring segment and the second temperature measuring segment are greater than or equal to 300 ppm/° C.

Preferably, the width of the first temperature measuring segment is 0.1 mm-3 mm; and/or
the width of the second temperature measuring segment is 0.2 mm-6 mm.

Preferably, the heating element includes a heating portion and a conductive portion that are connected; the heating portion includes a heating base and an infrared radiation layer covering the heating base.

In the present application, an aerosol generating device is further constructed. The aerosol generating device includes the heating structure described in any one of the foregoing aspects.

The present application has at least the following beneficial effects. By reasonably allocating the resistance of the temperature measuring loop, the first temperature measuring segment with a relatively large resistance is provided corresponding to a particular temperature zone on the peripheral surface of the tube body so that the accuracy of representing the temperature of the particular temperature zone by the temperature measuring loop may be improved, thereby more accurately monitoring the temperature of the surface of the heating structure.

applicationapplicationapplicationapplicationapplicationapplicationapplicationapplicat ionapplicationapplicationapplicationapplicationapplicationapplicationTo provide a clearer understanding of the technical features, objectives, and effects of the present application, specific implementations of the present application are described with reference to the accompanying drawings.

It should be noted that, unless otherwise clearly specified and limited, “connected” should be understood in a generalized manner, such as directly connected or indirectly connected through an intermediate medium. The terms “first” and “second” are merely for facilitating the description of the technical solution, and should not be interpreted as indicating or implying relative importance or implicitly indicating the number of the technical features indicated. Thus, the features defined with “first” and “second” may explicitly or implicitly include one or more of such features. The specific meanings of the above-mentioned terms in the present application may be understood by a person skilled in the art according to specific circumstances.

The heating structure of the present application may be partially inserted into an aerosol generating substrate 4. Specifically, the heating structure may be partially inserted into a substrate segment of the aerosol generating substrate 4, and generates thermal radiation in a power-on state to heat the substrate segment of the aerosol generating substrate 4 so that the aerosol generating substrate 4 is atomized to generate aerosol. The thermal radiation may be thermal infrared radiation. The aerosol generating substrate 4 may be cylindrical. Specifically, the aerosol generating substrate may be a filamentous, sheet-like, or integrally formed solid material made from leaves and/or stems of plants (for example, tobacco), and aroma components may be further added to the solid material.

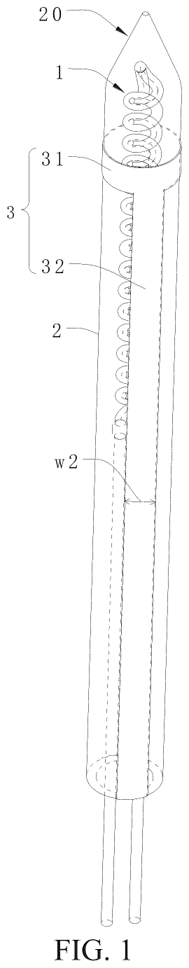

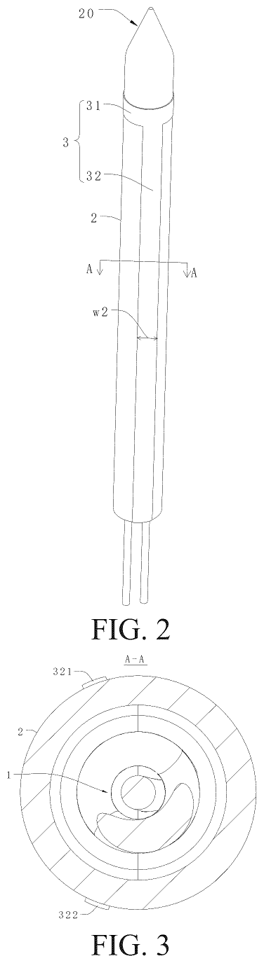

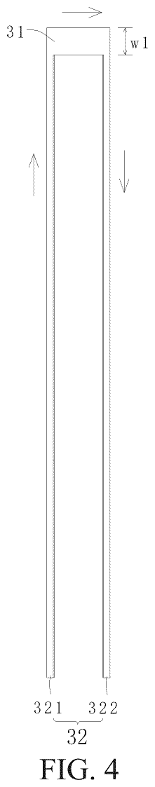

FIG. 1 to FIG. 4 shows a heating structure in a first embodiment of the present application. The heating structure includes a heating element 1, a tube body 2, and a thermal resistance temperature measuring element 3. The heating element 1 is partially accommodated in the tube body 2. It may be understood that, in other embodiments, the heating element 1 may alternatively be completely accommodated in the tube body 2. The heating element 1 generates infrared light in the power-on state, and the tube body 2 may allow the infrared light to penetrate through to reach the aerosol generating substrate 4, thereby facilitating the heating of the aerosol generating substrate 4 through the heat radiated from the heating element 1.

The tube body 2 may be a quartz glass tube or other window material that allows light waves to penetrate through, such as infrared-transparent glass, transparent ceramic, and diamond.

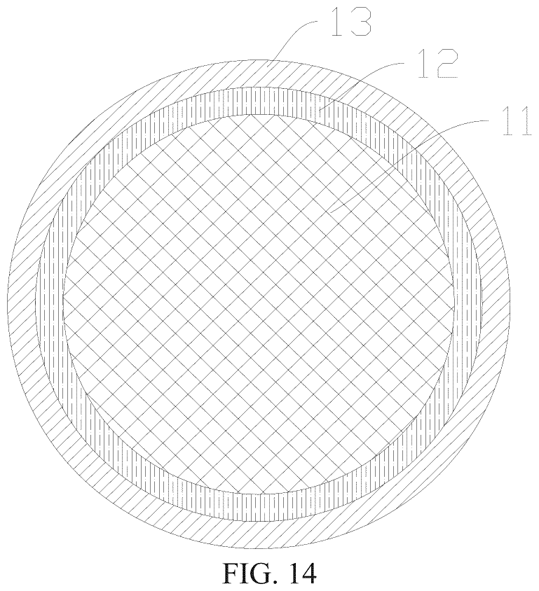

As shown in FIG. 14, in this embodiment, the heating element 1 includes a heating portion and a conductive portion that are connected. The heating portion and the conductive portion may be connected along the axial direction of the tube body 2. The heating portion includes a heating base 11 and an infrared radiation layer 13 covering the heating base 11. The heating base 11 may generate heat in a power-on state. The infrared radiation layer 13 is provided on the outer surface of the heating base 11 and is configured to radiate the infrared light. In this embodiment, cross sections of the heating base 11 and the infrared radiation layer 13 are concentrically distributed.

In some embodiments, the heating base 11 includes a metal base having high-temperature oxidation resistance, such as a metal wire, and may be a metal material having good high-temperature oxidation resistance, high stability, and resistance to deformation, such as a nickel-chromium alloy base (for example, a nickel-chromium alloy wire) or an iron-chromium-aluminum alloy base (for example, an iron-chromium-aluminum alloy wire). In some embodiments, the heating base 11 is a metal wire with a diameter of 0.15 mm-0.8 mm (including endpoint values and any value between the endpoint values). The metal wire may be bent or wound into various shapes, such as a spiral shape, a mesh shape, an M shape, or an N shape. The bent or wound heating element has a cylindrical shape, a spiral segment, a mesh shape, or other three-dimensional or planar shapes with bends as a whole.

In some embodiments, the heating portion further includes an anti-oxidation layer 12, and the anti-oxidation layer 12 is formed between the heating base 11 and the infrared radiation layer 13. Specifically, the anti-oxidation layer 12 may be an oxide film. A layer of dense oxide film is generated on the surface of the heating base 11 by performing high-temperature heat treatment. The oxide film forms the anti-oxidation layer 12. Certainly, it may be understood that, in other embodiments, the anti-oxidation layer 12 is not limited to including the oxide film formed by the anti-oxidation layer 12. In other embodiments, the anti-oxidation layer 12 may be an anti-oxidation coating coated on the outer surface of the heating base 11. The thickness of the anti-oxidation layer 12 may be selected to be in a range of 1 um-150 um (including endpoint values and any value between the endpoint values).

In some embodiments, the infrared radiation layer 13 may be an infrared layer. The infrared layer may be an infrared layer-generating base that is formed, under high-temperature heat treatment, on one side of the anti-oxidation layer 12 away from the heating base 11. Specifically, the infrared layer-generating base may be a silicon carbide base, a spinel base, or a composite base thereof. Certainly, it may be understood that, in other embodiments, the infrared radiation layer 13 is not limited to the infrared layer. In other embodiments, the infrared radiation layer 13 may be a composite infrared layer. Specifically, the infrared layer may be formed on one side of the anti-oxidation layer 12 away from the heating base 11 through dipping, spraying, brushing, and other methods. The thickness of the infrared radiation layer 13 may be 10 um-300 um (including endpoint values and any value between the endpoint values).

Specifically, in this embodiment, an air gap is reserved between the inner wall of the tube body 2 and the heating element 1. In the power-on state, the heating element 1 may quickly heat up to about 1000° C. within 1-3 s, the surface temperature of the tube body 2 may be controlled at about 350° C. for most of the time (in some embodiments, the surface temperature of the tube body 2 may reach 550° C. during a part of the preheating phase), and the overall atomization temperature of the aerosol generating substrate 4 is controlled at 300° C.-350° C., thereby achieving precise atomization of the aerosol generating substrate 4 within bands of 2 μm-5 um (including endpoint values and any value between the endpoint values) and 8 μm-11 μm (including endpoint values and any value between the endpoint values). The maximum operating temperature of the heating element 1 of the present application is 500° C.-1,300° C., which is much higher than the maximum operating temperature of the heating element 1 in the related art. In addition, the heating element 1 of the present application is heated quickly. The maximum operating temperature of the heating element 1 herein refers to temperature peaks in different time periods, for example, a temperature peak in the preheating phase and a temperature peak in each vaping phase.

When the heating element 1 is heated quickly and has a relatively high maximum operating temperature, a corresponding requirement on the temperature control precision is also relatively high. Correspondingly, in this embodiment:

The thermal resistance temperature measuring element 3 includes a first temperature measuring segment 31 and a second temperature measuring segment 32 that are provided on the peripheral surface of the tube body 2. The first temperature measuring segment 31 and the second temperature measuring segment 32 may be provided on the inner peripheral surface of the tube body 2 or the outer peripheral surface of the tube body 2. Considering the actual process difficulty, the first temperature measuring segment 31 and the second temperature measuring segment 32 are preferably provided on the outer peripheral surface of the tube body 2. After the first temperature measuring segment 31 and the second temperature measuring segment 32 are connected, a temperature measuring loop is formed. The peripheral surface of the tube body 2 includes a plurality of temperature zones along the axial direction of the tube body 2. It should be noted that since the temperature distribution of the tube body 2 is not uniform everywhere, there will be relatively high and low temperature distributions. Herein, the temperature zones may be different region segments distributed along the axial direction of the tube body 2. For example, each temperature zone may be an annular surface or an arc surface with an axial width of 0.2-5 mm. It may be understood that the foregoing dimensions and shapes are variable, and are defined and divided according to the characteristics of the actual heating element.

The resistance of the first temperature measuring segment 31 is greater than the resistance of the second temperature measuring segment 32, and the first temperature measuring segment 31 is provided corresponding to one of the temperature zones on the peripheral surface of the tube body 2. Specifically, the first temperature measuring segment 31 may be completely located in one of the temperature zones on the peripheral surface of the tube body 2. Alternatively, a part of the first temperature measuring segment 31 is located in one of the temperature zones on the peripheral surface of the tube body 2. According to influencing factors of the resistance change of a conductor, the resistance of the first temperature measuring segment 31 is provided to be greater than the resistance of the second temperature measuring segment 32 by reasonably configuring the material, length, width, conductor cross-sectional area, and the like of the first temperature measuring segment 31 and the second temperature measuring segment 32. The first temperature measuring segment 31 and the second temperature measuring segment 32 may be temperature measuring films having relatively small thicknesses.

The plurality of temperature zones may include a high-temperature zone, a medium-temperature zone, and a low-temperature zone. Specifically, the plurality of temperature zones may be divided based on the length of the tube body in the axial direction. The divided regions may be different according to structural features of different heating elements. As described above, in this embodiment, the heating element 1 includes a heating portion and a conductive portion that are connected. The heating portion is completely located in the tube body 2. A part of the conductive portion is located in the tube body 2, and the other part of the conductive portion leads out from an opening of the tube body 2 and is connected to a power supply. The heating portion includes a spiral segment, which is a heating wire. The heating wire is wound into a spiral shape and is longitudinally provided. Specifically, the heating portion may be cylindrical as a whole and may be wound to form a single-spiral structure, double-spiral structure, M-shaped structure, N-shaped structure, or structure with another shape. Certainly, it may be understood that, in other embodiments, the number of heating portions is not limited to one, and there may be two or more heating portions. The shape of the heating portion may alternatively be a sheet. In this embodiment, the spiral segment of the heating portion corresponds to the high-temperature zone, the conductive portion corresponds to the low-temperature zone, and a medium-temperature zone is formed between the spiral segment and the conductive portion.

Therefore, in this embodiment, the temperature field distribution on the peripheral surface of the tube body 2 in an operating state, i.e., on the axial direction of the tube body 2 after being inserted into the aerosol generating substrate 4, is as follows: the temperature of the whole heating portion is higher than the temperature of the whole conductive portion, the temperature at two ends of the heating portion is relatively low, and the temperature between the two ends is relatively high. Therefore, the peripheral surface of the tube body 2 may be divided into a high-temperature zone, a medium-temperature zone, and a low-temperature zone along the axial direction of the tube body 2. A position corresponding to the heating portion is the high-temperature zone. A position corresponding to the conductive portion is the low-temperature zone. A medium-temperature zone connecting the high-temperature zone and the low-temperature zone may be further provided between the high-temperature zone and the low-temperature zone. The medium-temperature zone may be a connection position of the heating portion and the conductive portion or an extension of 1-5 mm above or/and below the connection position. Correspondingly, when the particular temperature zone is a high-temperature zone, all or most of the first temperature measuring segment 31 may be provided in the high-temperature zone. When the particular temperature zone is a medium-temperature zone, all or most of the first temperature measuring segment 31 may be provided in the medium-temperature zone. When the particular temperature zone is a low-temperature zone, all or most of the first temperature measuring segment 31 may be provided in the low-temperature zone. It may be understood that, in other embodiments, the plurality of temperature zones may alternatively be distributed in other forms.

In this way, by reasonably allocating the resistance of the temperature measuring loop, the first temperature measuring segment 31 with a relatively large resistance is provided corresponding to the particular temperature zone on the peripheral surface of the tube body 2 so that the accuracy of representing the temperature of the particular temperature zone by the temperature measuring loop may be improved. In particular, the temperatures of the medium-temperature zone and the high-temperature zone may be accurately represented, thereby more accurately monitoring the temperature of the surface of the heating structure. In some preferred embodiments, a ratio of a resistance value of the first temperature measuring segment 31 to a resistance value of the second temperature measuring segment 32 is greater than or equal to 2.

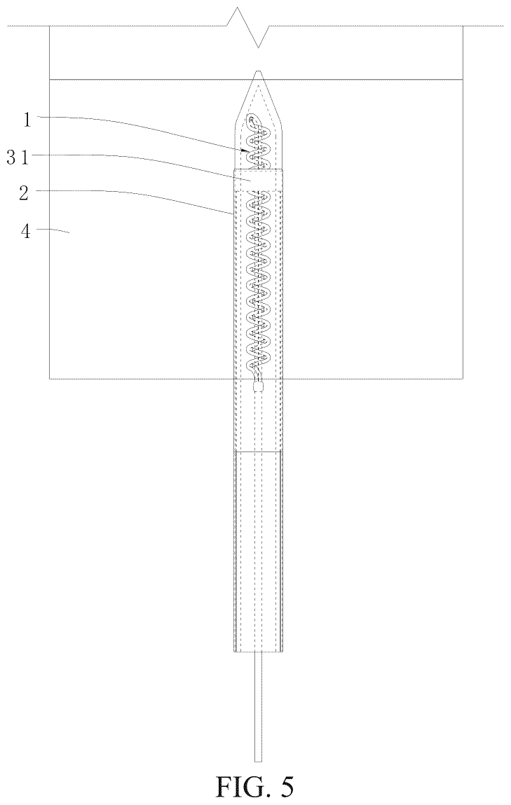

FIG. 5 to FIG. 8 show states of the temperature measuring loop, in particular the first temperature measuring segment 31, provided at four positions on the outer peripheral surface of the tube body 2, respectively, and a relative positional relationship between the first temperature measuring segment 31 and the aerosol generating substrate 4 after the tube body 2 is inserted into the aerosol generating substrate 4 in this embodiment. The tube body 2 includes a first end and a second end that are opposite. The first end includes a pointed top structure 20, configured to insert into the aerosol generating substrate 4. The second end of the tube body 2 is located outside the aerosol generating substrate 4.

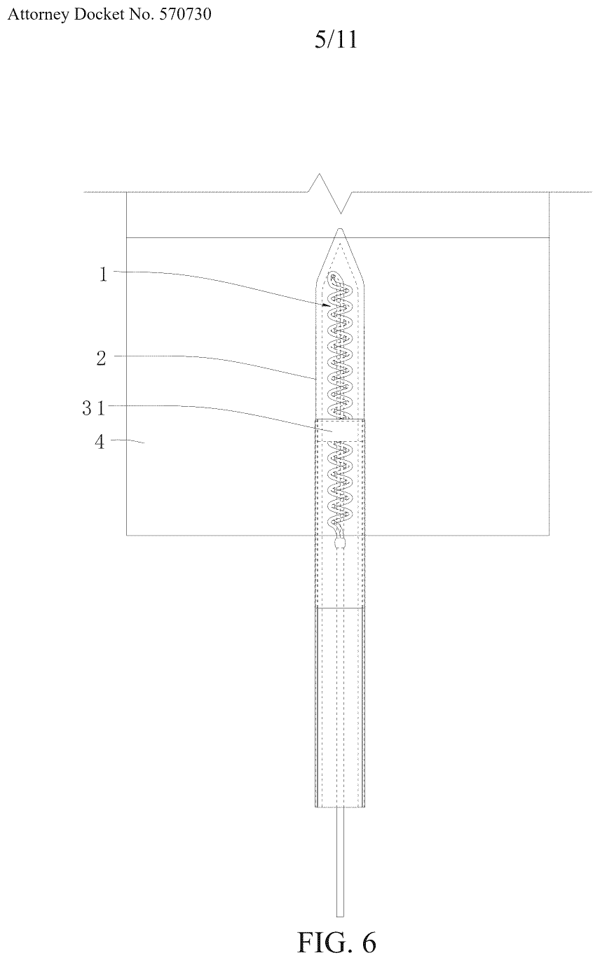

As shown in FIG. 5 and FIG. 6, at a first position and a second position, the first temperature measuring segment 31 is located on the outer peripheral surface of the tube body 2 and is close to an axial midpoint of the heating portion in the tube body 2. At the first position and the second position, the first temperature measuring segment 31 is correspondingly provided on the high-temperature zone of the tube body 2. The first position is closer to the pointed top structure 20 of the tube body 2 relative to the second position. For the first position, the distance between the first temperature measuring segment 31 and the tip of the pointed top structure 20 of the tube body 2 may be 3-5 mm (including endpoint values and any value between the endpoint values). For the second position, the distance between the first temperature measuring segment 31 and the tip of the pointed top structure 20 of the tube body 2 may be 7 mm-9 mm (including endpoint values and any value between the endpoint values).

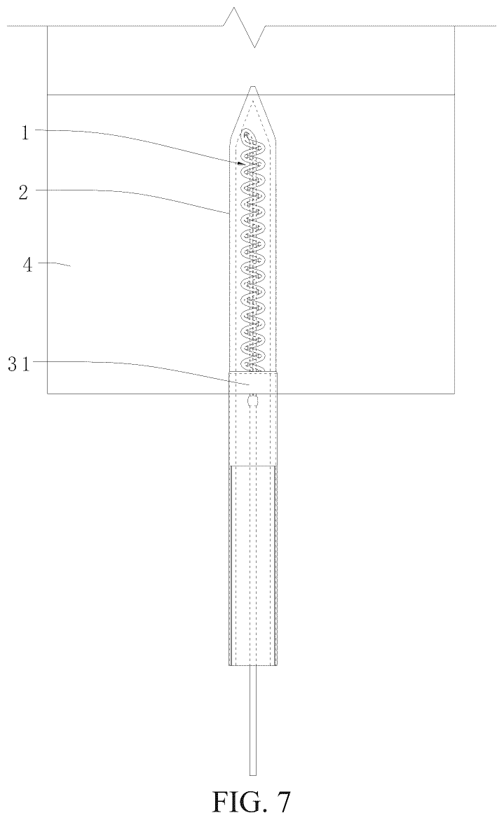

As shown in FIG. 7, at a third position, the first temperature measuring segment 31 is located on the outer peripheral surface of the tube body 2 and is farther away from the pointed top structure 20 of the tube body 2 relative to the second position. In this case, the first temperature measuring segment 31 is located at the lowest part of the aerosol generating substrate 4, but is still located in the aerosol generating substrate 4. In this case, the first temperature measuring segment 31 is correspondingly provided on the medium-temperature zone of the tube body 2. For the third position, the distance between the first temperature measuring segment 31 and the tip of the pointed top structure 20 of the tube body 2 may be 11 mm-13 mm (including endpoint values and any value between the endpoint values).

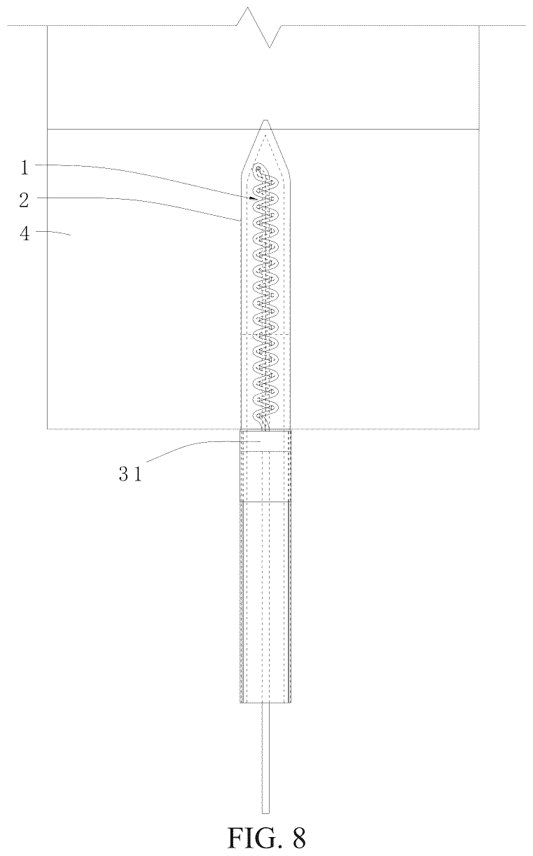

As shown in FIG. 8, at a fourth position, the first temperature measuring segment 31 is located on the outer peripheral surface of the tube body 2 and is farther away from the pointed top structure 20 of the tube body 2 relative to the third position. In this case, the first temperature measuring segment 31 is located outside the aerosol generating substrate 4. In this case, the first temperature measuring segment 31 is correspondingly provided on the medium-temperature zone of the tube body 2. For the fourth position, the distance between the first temperature measuring segment 31 and the tip of the pointed top structure 20 of the tube body 2 may be 15 mm-18 mm (including endpoint values and any value between the endpoint values).

According to influencing factors of the resistance of the conductor, combined with the difficulty of the actual process operation, for ease of actual operation, a core technical solution of the present application may further be embodied from another aspect: the width w1 of the first temperature measuring segment 31 is less than the width w2 of the second temperature measuring segment 32, and the first temperature measuring segment 31 is provided corresponding to one of the temperature zones on the peripheral surface of the tube body 2; and/or the thickness of the first temperature measuring segment 31 is less than the thickness of the second temperature measuring segment 32, and the first temperature measuring segment 31 is provided corresponding to one of the temperature zones on the peripheral surface of the tube body 2.

The length direction of the first temperature measuring segment 31 (or the second temperature measuring segment 32) is consistent with the current flow direction (as indicated by the arrow in FIG. 3) of the temperature measuring loop. A direction on the first temperature measuring segment 31 (or the second temperature measuring segment 32) perpendicular to the current flow direction of the temperature measuring loop corresponds to the conductor cross-sectional area (the area through which the current passes) of the first temperature measuring segment 31, including the width and the thickness.

That is, the width w1 of the first temperature measuring segment 31 may be set to be smaller than the width w2 of the second temperature measuring segment 32, or the thickness of the first temperature measuring segment 31 may be set to be smaller than the thickness of the second temperature measuring segment 32. Alternatively, the width w1 of the first temperature measuring segment 31 may be set to be smaller than the width w2 of the second temperature measuring segment 32, and the thickness of the first temperature measuring segment 31 may be set to be smaller than the thickness of the second temperature measuring segment 32. In this way, the conductor cross-sectional area of the first temperature measuring segment 31 may be set to be smaller than the conductor cross-sectional area of the second temperature measuring segment 32 so that the resistance of the first temperature measuring segment 31 is greater than the resistance of the second temperature measuring segment 32, thereby representing the temperature of the particular temperature zone.

Further, the ratio of the resistance value of the first temperature measuring segment 31 to the resistance value of the second temperature measuring segment 32 is greater than or equal to 2.

Further, the width w1 of the first temperature measuring segment 31 may be 0.1 mm-3 mm. The width w2 of the second temperature measuring segment 32 may be 0.2 mm-6 mm. It should be noted that the width w1 of the first temperature measuring segment 31 may be 0.1 mm, 3 mm, or any value between 0.1 mm and 3 mm. The width w2 of the second temperature measuring segment 32 may be 0.2 mm, 6 mm, or any value between 0.2 mm and 6 mm.

In this embodiment, the first temperature measuring segment 31 extends along the peripheral direction of the tube body 2. The second temperature measuring segment 32 extends along the axial direction of the tube body 2. Therefore, the first temperature measuring segment 31 is directly connected to the second temperature measuring segment 32 at an included angle. After the first temperature measuring segment 31 and the second temperature measuring segment 32 are connected, a temperature measuring loop is formed to represent the temperature of a particular temperature zone on the peripheral surface of the tube body 2. The arrow in FIG. 3 shows the current flow direction of the temperature measuring loop formed by connecting the first temperature measuring segment 31 and the second temperature measuring segment 32. Specifically, the first temperature measuring segment 31 may be first correspondingly provided at a position in the axial direction of the tube body 2 to represent the temperature of the temperature zone corresponding to the position. One end of the second temperature measuring segment 32 is connected to the power supply, and the other end of the second temperature measuring segment 32 is connected to the first temperature measuring segment 31 to provide conduction support for the first temperature measuring segment 31, so as to ensure that the first temperature measuring segment 31 may be provided at any position in the axial direction of the tube body 2.

Referring primarily to FIG. 3, in this embodiment, the second temperature measuring segment 32 includes a first part 321 and a second part 322. The first temperature measuring segment 31 is connected between one end of the first part 321 of the second temperature measuring segment 32 and one end of the second part 322 of the second temperature measuring segment 32. The other end of the first part 321 of the second temperature measuring segment 32 and the other end of the second part 322 of the second temperature measuring segment 32 are connected to the power supply. Alternatively, more specifically, the first temperature measuring segment 31 includes two opposite ends. The first part 321 of the second temperature measuring segment 32 includes a first end and a second end that are opposite, and the second part 322 of the second temperature measuring segment 32 also includes a first end and a second end that are opposite. One end of the first temperature measuring segment 31 is connected to the first end of the first part 321 of the second temperature measuring segment 32. The other end of the first temperature measuring segment 31 is connected to the first end of the second part 322 of the second temperature measuring segment 32. The second end of the first part 321 of the second temperature measuring segment 32 and the second end of the second part 322 of the second temperature measuring segment 32 are connected to the power supply. The power supply may be connected to a temperature detection apparatus or a control center, and feeds back temperature data measured by the temperature measuring loop in real time.

Specifically, in this embodiment, the first part 321 and the second part 322 of the second temperature measuring segment 32 are parallel to each other and have the same length, and are both configured in a longitudinal shape parallel to the central axis of the tube body 2. Correspondingly, the first temperature measuring segment 31 is perpendicular to the first part 321 and the second part 322 of the second temperature measuring segment 32. That is, two right angles are formed after the first temperature measuring segment 31 and the second temperature measuring segment 32 are connected. Certainly, in other embodiments, the lengths of the first part 321 and the second part 322 may be different, the first part 321 and the second part 322 may not be parallel to each other, and the first temperature measuring segment 31 may not be perpendicular to the first part 321 and the second part 322 of the second temperature measuring segment 32. It may be understood that, in other embodiments, the second temperature measuring segment 32 may further include a plurality of parts such as a third part and a fourth part.

Referring primarily to FIG. 3, in this embodiment, the peripheral surface of the tube body 2 includes two symmetrical semi-circular arc surface regions, and the first part 321 and the second part 322 of the second temperature measuring segment 32 are entirely located on one of the semi-circular arc surface regions. Alternatively, the first part 321 and the second part 322 of the second temperature measuring segment 32 are non-axisymmetrically distributed on the peripheral surface of the tube body 2 along the central axis of the tube body 2.

As described above, the tube body 2 is configured to allow the infrared light to penetrate through to reach the aerosol generating substrate 4. When the thermal resistance temperature measuring element 3 is provided on the peripheral surface of the tube body 2, a part of the tube body 2 is inevitably covered and blocked. When the first part 321 and the second part 322 of the second temperature measuring segment 32 are configured to be symmetrically distributed on the peripheral surface of the tube body 2 along the central axis of the tube body 2, a part of light waves (approximately regarded as straight lines) of the infrared light that is penetrated through the tube body 2 are completely blocked by the symmetrically distributed second temperature measuring segment 32, which may cause the negative impact such as an increase in the surface temperature of the tube body 2 and affect the heating of the aerosol generating substrate 4 by the light waves. However, the negative impact may be offset from two aspects. In the first aspect, the surface areas and thicknesses of the first part 321 and the second part 322 of the second temperature measuring segment 32 may be set to be very small so that the area ratio of the blocked part of the tube body 2 is very small. Thus, the surface temperature of the tube body 2 may be reduced, and the blocked light wave loss is reduced. Therefore, there is little impact on the heating performance of the aerosol generating substrate 4. In the other aspect, when the surface temperature of the tube body 2 is excessively high, the spacing of the spiral segment of the heating portion may be increased to appropriately reduce the temperature of the heating portion so that the surface temperature of the tube body 2 may be reduced. Therefore, there is little impact on the overall heating performance of the heating element 1. Therefore, further, in this embodiment, the means of the third aspect is as follows. The first part 321 and the second part 322 of the second temperature measuring segment 32 are entirely located on one of the semi-circular arc surface regions so that a part of the infrared light blocked by the second temperature measuring segment 32 may be reflected along the radial direction of the tube body 2, thereby reducing the light wave energy loss and minimizing the negative impact caused by blockage of the tube body 2.

In this embodiment, the second temperature measuring segment 32 further includes an electrode, and the electrode is connected between the power supply and the first temperature measuring segment 31.

Further, in this embodiment, a material of the electrode may be a metal material having high conductivity, and may specifically include one or more of gold, silver, platinum, and copper. A material of the part of the second temperature measuring segment 32 except the electrode may include a resistive material having conductive performance, and may specifically include one or more of platinum, gold, silver, chromium, and nickel.

In this embodiment, a resistance value of the part of the second temperature measuring segment 32 except the electrode and/or a resistance value of the first temperature measuring segment 31 is greater than or equal to twice a resistance value of the electrode. That is, the resistance value of the part of the second temperature measuring segment 32 except the electrode is greater than or equal to twice the resistance value of the electrode. Alternatively, the resistance value of the first temperature measuring segment 31 is greater than or equal to twice the resistance value of the electrode. Further alternatively, the resistance value of the part of the second temperature measuring segment 32 except the electrode and the resistance value of the first temperature measuring segment 31 are both greater than or equal to twice the resistance value of the electrode. Therefore, the temperature measuring loop may more accurately represent the temperature of the particular temperature zone on the tube body 2.

Referring to the following Table 1, test data of this embodiment is shown. R₂ is the resistance value of the first temperature measuring segment 31. R₁ is a resistance value of the first part 321 of the second temperature measuring segment 32. R₃ is a resistance value of the second part 322 of the second temperature measuring segment 32. A plurality of thermocouples are arranged on the peripheral surface of the tube body 2 along the axial direction of the tube body 2. The plurality of thermocouples are provided corresponding to positions of the first part 321 of the second temperature measuring segment 32, the first temperature measuring segment 31, and the second part 322 of the second temperature measuring segment 32 on the tube body 2, respectively. The temperatures measured by the plurality of thermocouples are T₁, T₂, and T₃, respectively. Specifically, T₂ represents the temperature of the position of the first temperature measuring segment 31 on the tube body 2. The material TCR of the temperature measuring loop is 1,500 ppm/° C., that is, the material TCRs of both the first temperature measuring segment 31 and the second temperature measuring segment 32 are 1,500 ppm/° C. Resistance values of R₁, R₂, and R₃ are changed by changing the conductor cross-sectional areas of the first temperature measuring segment 31 and the second temperature measuring segment 32, and the temperature fed back by the corresponding temperature measuring loop changes with the change of the resistance values of R₁, R₂, and R₃.

When the resistance values of R₁, R₂, and R₃ are all 1Ω, T₁ and T₃ are heated to 100° C., and T₂ is heated to 300° C., the temperature fed back by the temperature measuring loop is 167° C. When T₁, T₂, and T₃ remain unchanged, the conductor cross-sectional area of the first temperature measuring segment 31 is changed, and R₂ is raised to 2Ω, 4Ω, and 8Ω, respectively, the temperatures Tₘₑₐₛᵤᵣₑ fed back by the temperature measuring loop are 200° C., 233° C., and 260° C. It should be noted that, the resistance values of the first temperature measuring segment 31 and the second temperature measuring segment 32 are adjusted, the resistance values of R₁, R₂, and R₃ are reasonably allocated, and R₂ is set to be greater than R₁ and R₃ so that a difference between the temperature fed back by the temperature measuring loop and the actual temperature at the corresponding position on the surface of the tube body 2 may be reduced, thereby reducing an error of the temperature measured by the temperature measuring loop and improving the accuracy of representing the temperature of the particular temperature zone by the temperature measuring loop.

TABLE 1
Resistance values and temperature distribution at
different positions of temperature measuring loop

| TCR/ppm · ° C.⁻¹ | R₁/Ω | R₂/Ω | R₃/Ω | T₁/° C. | T₂/° C. | T₃/° C. | Tₘₑₐₛᵤᵣₑ/° C. |
|---|---|---|---|---|---|---|---|
| 1500 | 1 | 1 | 1 | 100 | 300 | 100 | 167 |
| 1500 | 1 | 2 | 1 | 100 | 300 | 100 | 200 |
| 1500 | 1 | 4 | 1 | 100 | 300 | 100 | 233 |
| 1500 | 1 | 8 | 1 | 100 | 300 | 100 | 260 |

In this embodiment, the material of the first temperature measuring segment 31 is a resistive material having conductive performance, and may specifically include one or more of platinum, gold, silver, chromium, and nickel.

In this embodiment, the thermal resistance temperature measuring element 3 further includes a glaze layer provided on the surface of the first temperature measuring segment 31 and/or the second temperature measuring segment 32. That is, the glaze layer may be provided only on the surface of the first temperature measuring segment 31, the glaze layer may be provided only on the surface of the second temperature measuring segment 32, or the glaze layer may be provided simultaneously on the surfaces of the first temperature measuring segment 31 and the second temperature measuring segment 32. The glaze layer is configured to improve the high-temperature stability and flaking resistance of the temperature measuring loop. The glaze layer may be formed on the surface of the first temperature measuring segment 31 and/or the second temperature measuring segment 32 through high-temperature sintering by dipping or screen printing.

Further, the material of the glaze layer may include SiO₂ and other oxides. The weight percentage of SiO₂ may be greater than or equal to 95%.

As shown in FIG. 1 to FIG. 8, in this embodiment, the first temperature measuring segment 31 extends along the peripheral direction of the tube body 2 for one circle to form an annulus and is connected between the first part 321 and the second part 322 of the second temperature measuring segment 32. The first temperature measuring segment 31 is provided around the peripheral surface of the tube body 2 to form a circular blockage on the peripheral surface of the tube body 2, as described above. To reduce the impact of the blockage on the surface temperature of the tube body 2, the spacing of the spiral segment of the heating portion corresponding to the position of the first temperature measuring segment 31 may be increased to appropriately reduce the temperature of the heating portion so that the surface temperature of the tube body 2 may be reduced. Therefore, there is little impact on the overall heating performance of the heating element 1.

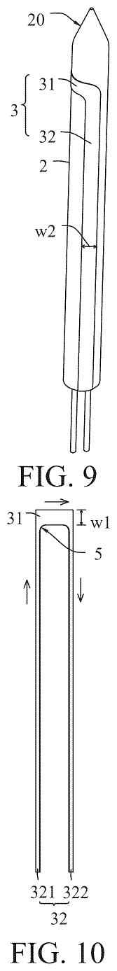

FIG. 9 to FIG. 10 show a heating structure in a second embodiment of the present application, which is different from the first embodiment in that the extension length of a part of the first temperature measuring segment 31 extending along the peripheral direction of the tube body 2 is less than the circumference of the tube body 2. That is, the first temperature measuring segment 31 does not form an annulus, but extends along the peripheral direction of the tube body 2 for a distance less than the circumference of the tube body 2. In addition, two opposite ends of the first temperature measuring segment 31 are connected to the first part 321 and the second part 322 of the second temperature measuring segment, respectively, to form a temperature measuring loop. Specifically, the outer diameter of the tube body 2 may be 2 mm-3.5 mm (including endpoint values and any value between the endpoint values), and the first temperature measuring segment 31 may extend along the peripheral direction of the tube body 2 for 2 mm-8 mm (including endpoint values and any value between the endpoint values). The distance that the first temperature measuring segment 31 extends along the peripheral direction of the tube body 2 may be set with reference to a specific value of the outer circumference or the inner circumference of the tube body 2.

Further, as shown in FIG. 10, in this embodiment, an arc-shaped transition zone 5 is formed at a junction of the first temperature measuring segment 31 and the second temperature measuring segment 32. Certainly, in other embodiments, a transition zone 5 of another shape, for example, a transition zone of an oblique angle shape, may alternatively be formed at the junction of the first temperature measuring segment 31 and the second temperature measuring segment 32.

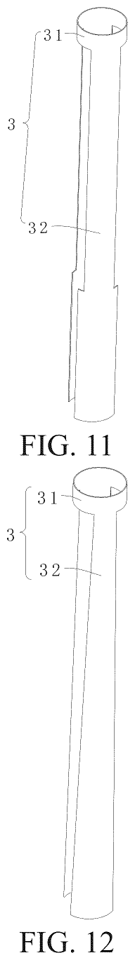

FIG. 11 shows a heating structure in a third embodiment of the present application, which is different from the first embodiment and the second embodiment in that the second temperature measuring segment 32 includes two regions having different widths. In addition, the width of a region close to the first temperature measuring segment 31 is less than the width of a region away from the first temperature measuring segment 31. As described above, the resistance of the first temperature measuring segment 31 is greater than the resistance of the second temperature measuring segment 32, and the first temperature measuring segment 31 is configured to be correspondingly provided on the particular temperature zone, thereby improving the accuracy of representing the temperature of the particular temperature zone by the temperature measuring loop. Therefore, relative to the region of the second temperature measuring segment 32 further away from the first temperature measuring segment 31, the region of the second temperature measuring segment 32 closer to the first temperature measuring segment 31 or a part of the region of the second temperature measuring segment 32 connected to the first temperature measuring segment 31 may be set to have a smaller width to increase the resistance of the region of the second temperature measuring segment 32 closer to the first temperature measuring segment 31, thereby further facilitating improving the accuracy of representing the temperature of the particular temperature zone on the tube body 2 by the temperature measuring loop. The width of the region of the second temperature measuring segment 32 close to the first temperature measuring segment 31 may be 0.5 mm. The width of the region of the second temperature measuring segment 32 away from the first temperature measuring segment 31 may be 2 mm-3 mm (including endpoint values and any value between the endpoint values). It may be understood that, in other embodiments, the second temperature measuring segment 32 may include three, four, or more regions having different widths.

Further, FIG. 12 shows a heating structure in a fourth embodiment of the present application, which is different from the first embodiment, the second embodiment, and the third embodiment in that the width of the second temperature measuring segment 32 gradually decreases in the direction towards the first temperature measuring segment 31. Beneficial effects of this embodiment are substantially the same as those of the third embodiment, which further facilitate improving the accuracy of representing the temperature of the particular temperature zone by the temperature measuring loop. However, the width of the second temperature measuring segment 32 in the fourth embodiment changes more uniformly.

In the first embodiment, other technical features that are not mentioned may be provided with reference to one or more of the second embodiment, the third embodiment, and the fourth embodiment. In the second embodiment, other technical features that are not mentioned may be provided with reference to one or more of the first embodiment, the third embodiment, and the fourth embodiment. In the third embodiment, other technical features that are not mentioned may be provided with reference to one or more of the first embodiment, the second embodiment, and the fourth embodiment. In the fourth embodiment, other technical features that are not mentioned may be provided with reference to one or more of the first embodiment, the second embodiment, and the third embodiment. Details are not described herein again.

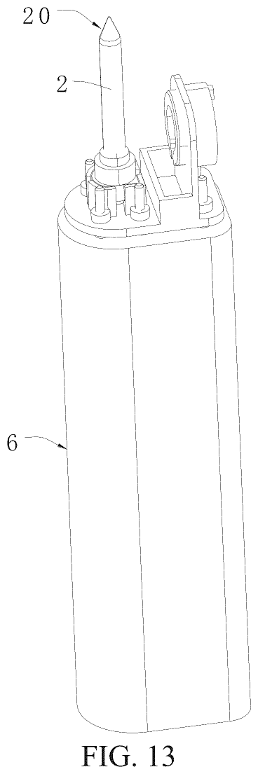

FIG. 13 shows an aerosol generating device in an embodiment of the present application. The aerosol generating device includes a power supply assembly, a support base 6, and a heating structure. The heating structure is detachably installed on the support base 6 to facilitate the replacement and maintenance of the heating structure. The power supply assembly is accommodated inside the support base 6. The support base 6 may be mechanically and electrically connected to the heating structure. It may not only support the heating structure, but also be electrically connected to the heating structure when the heating structure is installed on it, thereby electrically connecting the heating structure to the power supply assembly. The aerosol generating device may heat the aerosol generating substrate 4 in a low-temperature HNB manner, and has good atomization stability and good atomization taste.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A heating structure, comprising:
a heating element configured to generate infrared light in a power-on state;
a tube body configured to allow the infrared light to penetrate through; and
a temperature measuring element,
wherein the heating element is at least partially accommodated in the tube body,
wherein the temperature measuring element comprises a first temperature measuring segment and a second temperature measuring segment that are provided on a peripheral surface of the tube body, the first temperature measuring segment and the second temperature measuring segment being connected so as to form a temperature measuring loop,
wherein the peripheral surface of the tube body comprises a plurality of temperature zones along an axial direction of the tube body,
wherein the first temperature measuring segment is provided corresponding to one temperature zone of the plurality of temperature zones on the peripheral surface of the tube body.

2. The heating structure of claim 1,
wherein at least one of:
a width of the first temperature measuring segment is less than a width of the second temperature measuring segment, and the first temperature measuring segment is provided corresponding to one temperature zone of the plurality of temperature zones on the peripheral surface of the tube body, and
a thickness of the first temperature measuring segment is less than a thickness of the second temperature measuring segment, and the first temperature measuring segment is provided corresponding to one temperature zone of the plurality of temperature zones on the peripheral surface of the tube body.

3. The heating structure of claim 1, wherein a ratio of a resistance value of the first temperature measuring segment to a resistance value of the second temperature measuring segment is greater than or equal to two.

4. The heating structure of claim 1, wherein the first temperature measuring segment extends along a peripheral direction of the tube body,
wherein the second temperature measuring segment extends along the axial direction of the tube body
wherein one end of the second temperature measuring segment is connected to the first temperature measuring segment, and
wherein an other end of the second temperature measuring segment is connected to a power supply.

5. The heating structure of claim 4, wherein the second temperature measuring segment comprises a first part and a second part that extend along the axial direction of the tube body,
wherein the first temperature measuring segment is connected between one end of the first part of the second temperature measuring segment and one end of the second part of the second temperature measuring segment, and
an other end of the first part of the second temperature measuring segment and an other end of the second part of the second temperature measuring segment are connected to the power supply.

6. The heating structure of claim 5, wherein the peripheral surface of the tube body comprises two symmetrical semi-circular arc surface regions, and
wherein the first part and the second part of the second temperature measuring segment are entirely located on one semi-circular arc surface region of the semi-circular arc surface regions.

7. The heating structure of claim 4, wherein the second temperature measuring segment comprises a plurality of regions having different widths, and
wherein a width of a region of the plurality of regions having different widths close to the first temperature measuring segment is less than a width of a region of the plurality of regions having different widths away from the first temperature measuring segment.

8. The heating structure of claim 7, wherein the width of the second temperature measuring segment decreases in a direction towards the first temperature measuring segment.

9. The heating structure of claim 4, wherein the second temperature measuring segment comprises an electrode connected between the power supply and the first temperature measuring segment.

10. The heating structure of claim 9, wherein a material of the electrode comprises at least one of gold, silver, platinum, and copper, and
wherein a material of a part of the second temperature measuring segment except the electrode comprises at least one of platinum, gold, silver, chromium, and nickel.

11. The heating structure of claim 4, wherein the first temperature measuring segment extends along a peripheral direction of the tube body for one circle so as to form an annulus.

12. The heating structure of claim 4, wherein a length of the first temperature measuring segment extending along a peripheral direction of the tube body is less than a circumference of the tube body.

13. The heating structure of claim 1, wherein a material of the first temperature measuring segment comprises at least one of platinum, gold, silver, chromium, and nickel.

14. The heating structure of claim 1, further comprising:
a glaze layer provided on a surface of at least one of the first temperature measuring segment and the second temperature measuring segment.

15. The heating structure of claim 1, wherein temperature coefficients of resistance (TCRs) of the first temperature measuring segment and the second temperature measuring segment are greater than or equal to 300 ppm/° C.

16. The heating structure of claim 1, wherein at least one of
a width of the first temperature measuring segment is 0.1 mm-3 mm, and
a width of the second temperature measuring segment is 0.2 mm-6 mm.

17. The heating structure of claim 1, wherein the heating element comprises a heating portion and a conductive portion that are connected, and
wherein the heating portion comprises a heating base and an infrared radiation layer covering the heating base.

18. An aerosol generating device, comprising:
the heating structure of claim 1.

19. The heating structure of claim 1, wherein a resistance of the first temperature measuring segment is greater than a resistance of the second temperature measuring segment.
